(19) United States
(12) Patent Application Publication
(10) Pub. No.: US 2011/0227834 A1
(43) Pub. Date: Sep. 22, 2011

(54) ELECTRONIC DEVICE WITH TOUCH KEYPAD

(75) Inventors: YU-QIU YANG, Shenzhen City (CN); SONG-LING YANG, Shenzhen City (CN)

(73) Assignees: HONG FU JIN PRECISION INDUSTRY (ShenZhen) Co., LTD., Shenzhen City (CN); HON HAI PRECISION INDUSTRY CO., LTD., Tu-Cheng (TW)

(21) Appl. No.: 12/845,708

(22) Filed: Jul. 28, 2010

(30) Foreign Application Priority Data
Mar. 22, 2010 (CN) 201010129343.X

(51) Int. Cl. G06F 3/02

(52) U.S. Cl. 345/169

(57) ABSTRACT

An electronic device includes a keypad, a circuit board, and a processing unit. The keypad includes a plurality of keys. Each of the keys includes a touch sensitive layer. The keypad is selectively operable between a touch input mode and a punch input mode. The touch sensitive layers cooperatively constitutes a unitary touch sensitive layer configured for sensing a touching track of a finger or a stylus thereon and controlling a movement track of a cursor or a scroll bar on a display screen based to the sensed touching track. In the punch input mode, the touch sensitive layers function individually and are configured to punch in numbers, letters, or characters. The processing unit is disposed on the circuit board and is configured for switching the keypad to operate between the touch input mode and the punch input mode.

### BACKGROUND

1. Technical Field

The present disclosure relates to an electronic device with a touch keypad.

2. Description of Related Art

A smart phone such as an IPHONE is equipped with a touch screen and does not have a keypad for input operation. However, touch screens are hard to type on and people are more accustomed to inputting with keypads. A keypad with a touch screen is employed in other mobile phones, however, their sizes are restricted due to the compact size of the mobile phone. Users usually need to operate the keypad at one time and operate the touch screen at another time, which is inconvenient.

A conventional desktop computer is usually equipped with a keyboard, and a mouse. Users often operate the keyboard to input symbols and operate the mouse to move a displayed cursor. That is, users usually operate the keyboard at one time and operate the mouse at another time, which is inconvenient. Other types of electronic devices such as PDAs also have similar problems.

Therefore, what is needed is an electronic device with touch keypad alleviating the limitations described above.

### BRIEF DESCRIPTION OF THE DRAWINGS

The components in the drawings are not necessarily drawn to scale, the emphasis instead being placed upon clearly illustrating the principles of an electronic device with a touch keypad and a keyboard with touch function. Moreover, in the drawings, like reference numerals designate corresponding parts throughout the several views.

FIG. 1 is an isometric view of a mobile phone with touch keypad in accordance with an exemplary embodiment.

FIG. 2 is an exploded, isometric view of the mobile phone of FIG. 1.

FIG. 3 is an isometric view of a keyboard with touch keypad in accordance with another embodiment.

### DETAILED DESCRIPTION

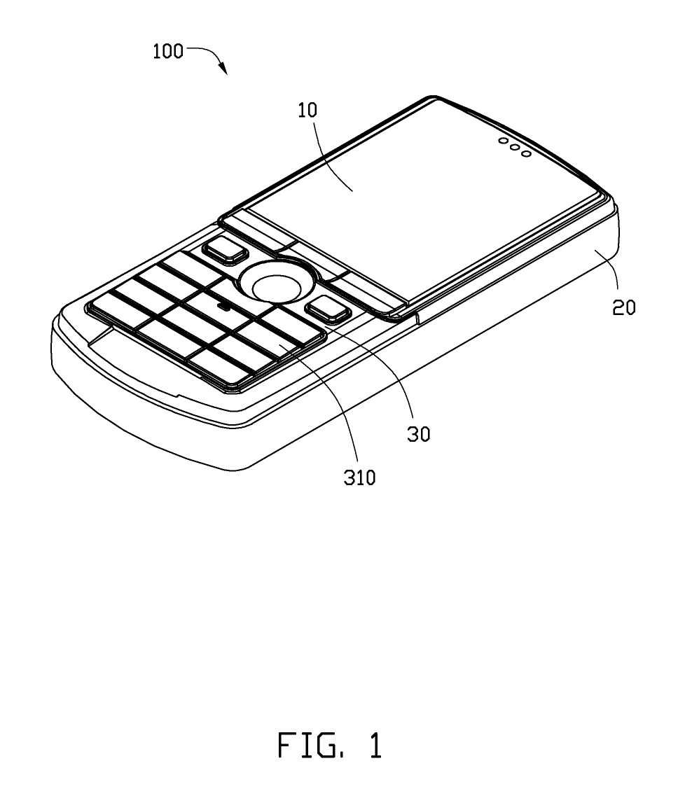

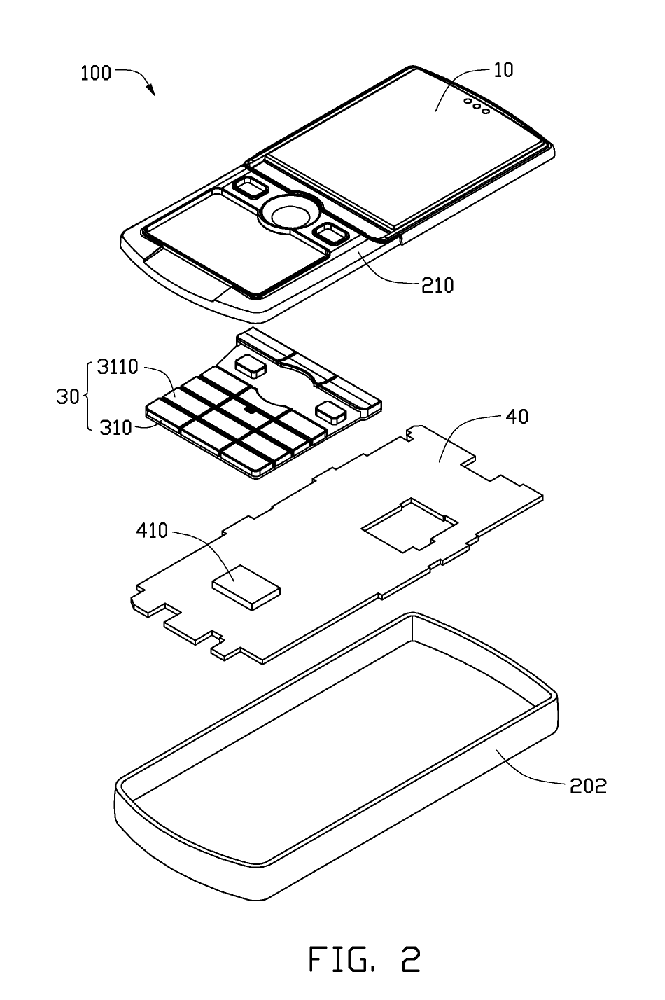

Referring to FIGS. 1-2, an embodiment of an electronic device with touch keypad is illustrated. In the illustrated embodiment, the electronic device 100 is a mobile phone. The mobile phone includes a display 10, a housing 20 and a keypad 30. The housing 20 includes a top cover 210 and a bottom cover 202 cooperatively forming a space for receiving the display 10 and the keypad 30. The mobile phone 100 includes a touch input mode and a punch input mode. Under the touch input mode, the keypad 30 is used similar to a touch pad. In the punch input mode, the keypad 30 is used as a conventional mechanical keypad.

The keypad 30 includes a plurality of keys 310. Each of the keys 310 includes a touch sensitive layer 3110. Each of the touch sensitive layers 3110 is configured to generate sensing signals in response to user input. In the touch input mode, the touch sensitive layers 3110 cooperatively constitute a unitary touch sensing layer for writing input with fingers or a stylus. The keypad 30 is configured for sensing a touching track of a finger or a stylus thereon and controlling a movement track of a cursor on the display screen based to the sensed touching track. In the punch input mode, the touch sensitive layers 3110 function individually. The touch sensitive layers 3110 cooperatively constitute a punch keypad. Each of the keys 310 is configured to correlate with at least a number, a letter, or a character. The punch keypad is configured for punching in numbers, letters, or characters. The mobile phone 100 further includes a circuit board 40 received in the housing 20. A processing unit 410 is disposed on the circuit board 40.

In the embodiment, the punch input mode is a default mode. In the punch input mode, if the processing unit 410 determines that a sliding touch operation is exerted on at least two adjacent keys 310, the processing unit 410 switches the punch input mode to the touch input mode. In the touch input mode, when no touch operation on the keypad 30 is detected within a predetermined time period, the processing unit 410 switches the touch input mode back to the punch input mode.

In the touch input mode, the processing unit 40 controls the movement of a cursor or a scrollbar displayed on the display 10 according to the sensing signals generated by any sliding touch operation on the keypad 30, similar on any conventional touch pad.

Furthermore, in the embodiment, under the touch input mode, when the keypad 30 is tapped for the first time, the processing unit 410 sets the tapped key 310 to act like the left mouse key, and each of the remaining keys to act like the right mouse key. That is, when the tapped key 310 is tapped again, the processing unit 410 performs a function which is conventionally triggered by the conventional left mouse key. When any of the remaining keys is tapped, the processing unit 410 performs a function which is conventionally triggered by the conventional right mouse key. In an alternative embodiment, under the touch input mode, when the keypad 30 is tapped for the first time, the processing unit 410 sets the tapped key 310 to act like the right mouse key, and each of the remaining keys to act like the left mouse key.

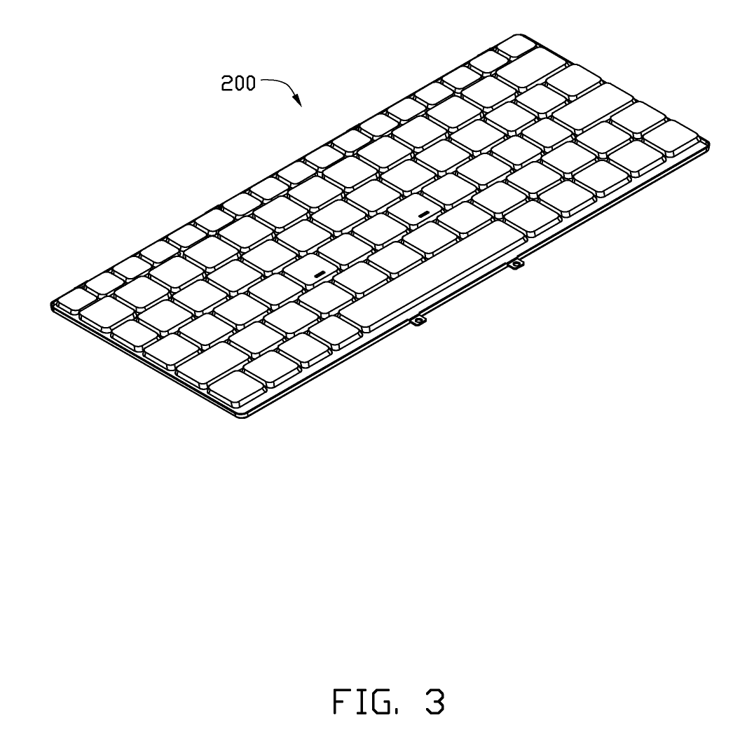

Referring to FIG. 3, an embodiment of an input device with touch keypad is illustrated. In the illustrated embodiment, the input device 200 is a keyboard. The keyboard 200 includes a number of keypads, such as a numeric keypad (not labeled), an alphabetic keypad (not labeled). Each of the keypads includes a plurality of keys (not labeled) and each of the keys includes a touch sensitive layer configured to punch in a predetermined number, a predetermined letter, or a predetermined character associated therewith. The keyboard 200 includes a circuit board (not shown) and a control unit (not shown) which function like the circuit board 40 and the processing unit 410 correspondingly when receiving signals from the keys. The control unit is configured for switching each touch sensitive layer to operate between the touch input mode and the punch input mode. the touch sensitive layer is

Not being limited to a mobile phone or a keyboard, the electronic device can be a plurality of electronic devices or input devices, such as a PDA, a portable computer, or the like.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device comprising:
a keypad comprising a plurality of keys, each of the keys comprising a touch sensitive layer, the keypad being selectively operable between a touch input mode where the touch sensitive layers cooperatively constitute a unitary touch sensitive layer configured for sensing a touching track of a finger or a stylus thereon and controlling a movement track of a cursor or a scroll bar on a display screen based to the sensed touching track, and a punch input mode where the touch sensitive layers function individually and are configured to punch in numbers, letters, or characters;
a circuit board; and
a processing unit disposed on the circuit board and configured for switching the keypad to operate between the touch input mode and the punch input mode.

2. The electronic device as described in claim 1, wherein the processing unit is configured for switching the keypad from the punch input mode to the touch input mode when the keypad senses a sliding touch operation is exerted on two adjacent keys.

3. The electronic device as described in claim 2, wherein the processing unit is configured for switching the keypad from the touch input to the punch input mode when the keypad senses no touch within a predetermined time period.

4. The electronic device as described in claim 1, wherein the processing unit is configured for switching the keypad to operate between the touch input mode and the punch input mode according to touch operations by a user on the keypad.

5. The electronic device as described in claim 1, wherein the processing unit is configured for setting a tapped key to be either one of a left mouse key and a right mouse key and each of the remaining keys to be another one of the left mouse key and the right mouse key when the keypad is tapped for the first time in the touch input mode.

6. The electronic device as described in claim 1, wherein the punch input mode is a default mode of the keypad.

7. The electronic device as described in claim 1, wherein the electronic device is a mobile phone, a keyboard, a PDA, or a portable computer.

8. An input device comprising:
a keypad comprising a plurality of keys, each of the keys comprising a touch sensitive layer, each touch sensitive layer being selectively operable between a touch input mode where the touch sensitive layer is configured for sensing a touching track of a finger or a stylus thereon and controlling a movement track of a cursor or a scroll bar on a display screen based to the sensed touching track, and a punch input mode where the touch sensitive layer is configured to punch in a predetermined number, a predetermined letter, or a predetermined character associated therewith; and
a control unit configured for switching each touch sensitive layer to operate between the touch input mode and the punch input mode.
